(19) United States
(12) Patent Application Publication
(10) Pub. No.: US 2016/0144464 A1
(43) Pub. Date: May 26, 2016

(54) Workpiece Support For Use In A Machine Tool

(71) Applicant: MAGNA INTERNATIONAL INC., Aurora (CA)

(72) Inventor: Markus Zwickl, Weiz (AT)

(21) Appl. No.: 14/904,574

(22) PCT Filed: Jun. 23, 2014
(86) PCT No.: PCT/CA2014/000517

§ 371 Date: Jan. 12, 2016

(30) Foreign Application Priority Data
Jul. 23, 2013 (DE) 102013214404.0

(51) Int. Cl. B23K 37/04; B23K 26/38

(52) U.S. Cl. CPC B23K 37/0408; B23K 26/38; B23K 37/0461

(57) ABSTRACT

A workpiece support for use in a machine tool for the purpose of placing flat workpieces in a machining station is provided. The flat workpiece is supported within a horizontal plane by supporting elements, and the supporting elements are arranged in at least two rows of supports. The rows of supports can be displaced along at least one axis of the horizontal plane.

The invention relates to the placement of flat workpieces in a machining station.

### PRIOR ART

In industrial manufacturing, materials are processed from rolls or from stacks, and are transformed using a wide variety of cutting and shaping tools into structured components. In the machining of sheet metals or plastic or composite materials, for example, laser cutting systems are used to produce the desired shapes and cut-outs. In this process, the material is machined on a workpiece support, which forms a planar base for the cutting or shaping tool.

It is a disadvantage of the various tools that the energy that is input through the raw material also impacts the workpiece support, e.g., a workpiece support would also exhibit machining traces caused by laser beam cutting.

Various design solutions for workpiece supports that are intended to prevent the tools from destroying the workpiece supports are known.

DE 10 2004 034 256 B4 discloses a device for cutting sheet metal. In this case, a metal sheet is transported in a transport direction by means of a conveyor device. The conveyor device has two transport devices arranged sequentially in the direction of transport.

Between two opposing ends of the transport devices, a gap is formed. The opposing ends of the transport devices can be moved in the same direction, in or counter to the direction of transport. Therefore, the gap can be displaced either in or counter to the direction of transport. A laser cutting device is positioned above the gap, with the laser beam thereof constantly directed toward the gap. The laser cutting device can be moved both in an X-direction, which corresponds to the direction of transport, and in a Y-direction, which is perpendicular thereto, so that any desired cut can be produced in a metal sheet being transported on the conveyor device. The gap is always moved concurrently with the laser beam. To produce a plurality of different contoured cuts, a plurality of such laser cutting devices can also be arranged, spaced from one another, along the direction of conveyance. —A similar device is also known from WO 2010/085486 A1.

From EP1340584 A1 a workpiece support is known, in which first and second supporting elements adjustably support the workpiece. In this case, support tips are provided, which are designed to be individually vertically adjustable, and which support the workpiece or retract from the workpiece.

In this arrangement, the workpieces are placed on the support tips in a batch process; however, this arrangement does not allow for a continuous process. Moreover, controlling this arrangement is complex and the supporting capacity of the individual tips is limited.

The object of the invention is to overcome the disadvantages of the prior art. The goal of the invention is to specify a device that is as compact in design as possible, and with which even long and complex machining processes can be carried out on a continuously infed strip of material at improved speed, while the strip of material is optimally supported.

The object is attained by the features of the claim. More particularly, the object is attained with a workpiece support that is designed for placing flat workpieces in a machining station, wherein the workpiece is supported within a horizontal plane by spaced supporting elements. The supporting elements are arranged in at least two rows of supports, which can be displaced along at least one axis in the horizontal plane.

By displacing the rows of supports, and thereby displacing the supporting elements relative to one another, open space is created below the workpiece, so that energy can be applied by a machine tool without impacting the support.

Advantageously, the supporting elements consist of a roller carrier with rollers.

The use of open spaces allows workpiece supports to be used for continuous operation, in which the workpiece material is infed from a strip.

The use of powered rollers also allows the workpiece to be displaced in the machining station during machining. The powered rollers also enable more than the workpiece to be displaced. The position of the rollers themselves can also be adjusted during operation, without thereby impacting the position (and/or the movement) of the workpiece. For this purpose, the top rollers are advantageously connected to a drive that acts on bottom rollers.

Advantageously, the distance between the supporting elements is smaller than the distance between the rows of supports. The reliable support of the workpiece on the workpiece support is thereby ensured, while at the same time creating sufficient open space to carry out processing.

The workpiece support is advantageously used in a machining station, has a cutting or shaping function, and is designed for either continuous operation or batch operation.

### BRIEF DESCRIPTION OF THE INVENTION

Advantageous embodiments of the invention are illustrated in the set of drawings and will be specified in greater detail in the following description.

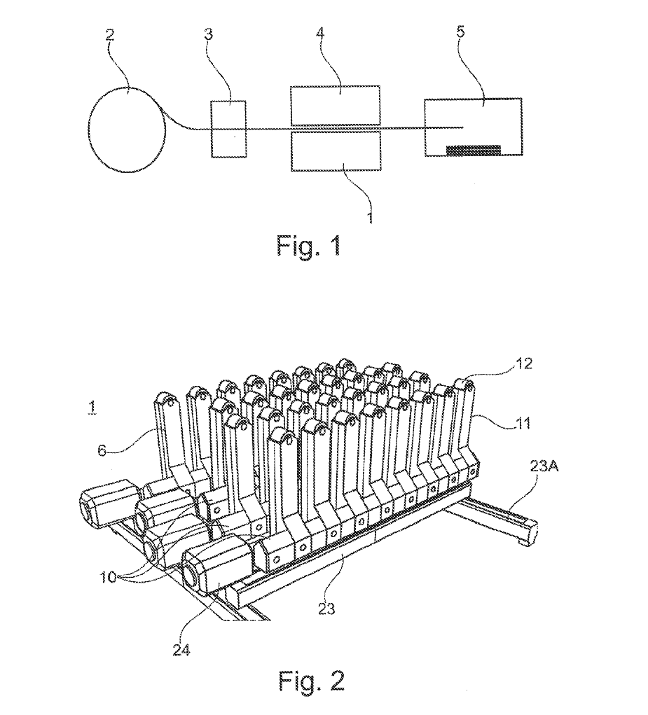

FIG. 1 shows a machine tool by way of example;

FIG. 2 shows a workpiece support;

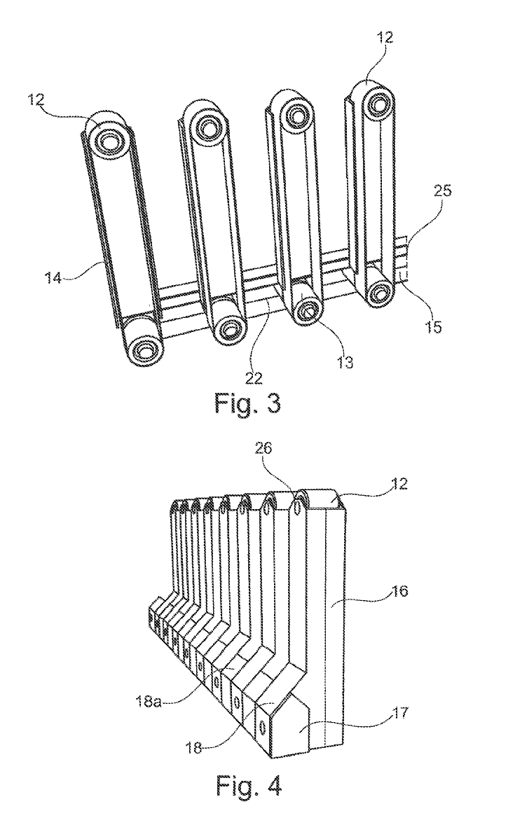

FIG. 3 shows a section of a row of supports;

FIG. 4 shows a row of supports with a housing;

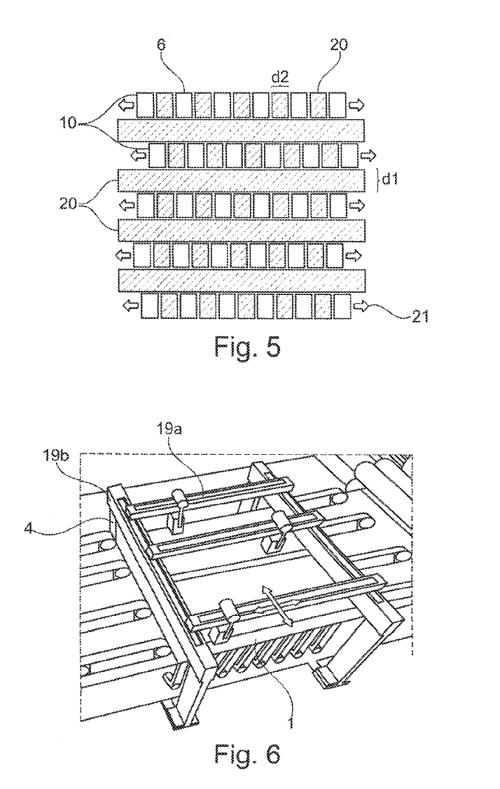

FIG. 5 shows a plan view of a workpiece support; and

FIG. 6 shows a machining station by way of example.

FIG. 1 shows an example of a machine tool, such as is used for producing contoured cuts in a metal sheet. In this case, the material, for example, the metal sheet, is fed into the machining process via a reel 2. In an alignment station 3, the material is either aligned or flattened or suitably prepared for further machining. The metal sheet is fed into a machining station 4 via known conveyor and transport devices. The machining station 4 in this case is disposed above the machining plane. The workpiece support 1 is positioned below the machining plane. After machining, the workpieces, which have now been separated, are delivered into a container 5. The machining unit 4 is a cutting unit, which operates in a contactless manner, for example, a laser cutting unit or a water jet cutting unit or a plasma cutting unit or an erosion cutting unit.

Common to all of these cutting units is that in order to cut the material, they must apply so much energy that a feed table would also be impacted.

The material to be machined can be metal, plastic or composite material.

FIG. 2 shows an overview of the workpiece support 1 according to the invention. The workpiece support 1 consists of supporting elements 6, which are arranged in rows of supports 10. In the illustrated example, four rows of supports 10 are shown. The rows of supports 10 are mounted on a support structure 23. A separate motor 24 is assigned to each row of supports 10.

FIG. 3 illustrates the details of the supporting elements 6. Each of the supporting elements 6 consists of a roller carrier 11, which terminates at both ends, top and bottom, with rollers, wherein the top roller 12 is the roller on which the workpiece rests. The bottom roller 13 is arranged on an assembly support 25 and is connected to the top roller 12 via a vertical belt drive 14. It is not absolutely necessary for rollers to be provided at the bottom. The entire assembly could also be implemented using shafts and bevel gears. In the interest of simplicity, the term roller is also extended to include shafts and bevel gears.

The bottom roller 13 extends along its axis into a drive roller 22, which is located inside the assembly support 25. The drive roller 22 is connected via a horizontal belt drive 15 to the motor 24, by which it is driven. As a result, when the motor is activated, all the drive rollers 22 in a row of supports 10 are actuated. The drive rollers 22 move the bottom rollers 13, which in turn operate the top rollers 12 via the vertical belt drive 14.

The workpieces are guided into the machining station and are positioned properly by powering the top rollers 12. Powering the rollers also allows the workpiece to be moved below the machining station and/or allows separated parts and/or waste to be discarded from the machining station. And the powered rollers can do more than displace the workpiece. It is also possible to adjust the position of the rollers themselves during operation, without thereby impacting the position (and/or the movement) of the workpiece.

In principle, regardless of whether the workpiece or the rollers are displaced, the drive will always compensate for the relative movement. For the laser line, both are required in order to allow different and any desired contours to be cut.

The height of the roller carrier 11, that is, the distance between top roller 12 and bottom roller 13, is based on the cutting machine used. In the case of laser cutting, the divergence of the laser beam is the decisive element, wherein beyond the focal point, the power drops off rapidly, and there is no further risk of damage to the support structure. A height of 300-500 mm therefore appears to be advantageous.

FIG. 4 illustrates a housing 16 for the row of supports 10. The housing 16 forms a capsule for the roller carrier 11. At the same time, at its upper end the housing supports the top roller 12 on an axle 26. A compartment 17 is shown at the lower end of the housing. Said compartment 17 encloses the assembly support 25. The compartment 17 has angled surfaces 18. The angled surfaces are positioned on one side and extend downward from the vertical housing structure. Angled sections 18a are likewise disposed in the interstices between the vertical housing parts, as an enclosure for the assembly support. The angled surfaces serve to guide any falling pieces of material, for example, cut-out scraps, such that they fall between the rows of supports and can be collected in a collecting container. At the same time, the angled surfaces 18, 18a serve to conduct the dust, machining mist and vapor away from the actual cutting process. The goal is to thereby minimize the amount of swirling particles.

FIG. 5 shows a plan view of the workpiece support 1. The rows of supports 10 in this drawing are arranged such that each is movable from left to right. The regions filled with hatch marks contain no supporting elements. Between the supporting elements 6, interstices 20 are arranged, spaced by distance d2. An interstice 20 having the distance d1 is provided between each of the rows of supports 10. The rows of supports 10 move linearly, allowing a cutting process to always be carried out along an interstice. A cutting unit is illustrated by way of example in FIG. 6. Here, a laser cutting unit is shown arranged on a machining platform, which has a longitudinal machining platform 19A and a transverse machining platform 19 so as to be displaceable in two directions. Additionally, by using three laser heads, highly rapid and efficient machining can be carried out. Combining such a laser cutting unit having two-dimensionally movable laser cutting heads with the movable supporting elements of the workpiece support enables a highly rapid and efficient machining of the workpiece. In this manner, complex contours such as circles and cut-outs can also be produced. Since the rollers in the rows of supports can be actuated independently of one another, the material can be positioned perfectly and the cutting process tracked. For movement: The rows of supports can be moved independently of one another and during machining operation from left to right. This is accomplished by means of the carrier 23. However, the entire package, that is, all the rows of supports at once, can also be displaced in the transverse direction. This is accomplished by means of the bottom carrier 23a. In this case, it is not necessary for the distance between the rows to be adjustable, which naturally results in a cost savings.

This transverse displacement is essential so that special contours (small circles, lengthwise cuts, etc.) can always be cut entirely within the region of the longitudinal gaps, without requiring that the rows be moved longitudinally for this purpose. Otherwise, some cuts could not be made.

### LEGEND

| | |
|---|---|
| 1 | workpiece support |
| 2 | roller |
| 3 | alignment station |
| 4 | machining station |
| 5 | container |
| 6 | supporting elements |
| 10 | row of supports |
| 11 | roller carrier |
| 12 | top roller |
| 13 | bottom roller |
| 14 | vertical belt drive |
| 15 | horizontal belt drive |
| 16 | housing |
| 17 | compartment |
| 18 | surface |
| 19a | longitudinal machining platform |
| 19b | transverse machining platform |
| 20 | interstices |
| 21 | displacement direction |
| 22 | drive rollers |
| 23 | CARRIER |
| 23a | bottom carrier |
| 24 | motor |
| 25 | assembly support |
| 26 | axle |

1. A workpiece support for use in a machine tool for the purpose of placing flat workpieces in a machining station, wherein the workpiece is supported within a horizontal plane by spaced supporting elements, wherein the supporting elements are arranged in at least two rows of supports, and the rows of supports are displaceable along at least one axis of the horizontal plane.

2. The workpiece support according to claim 1, wherein the supporting elements consist of a roller carrier with rollers.

3. The workpiece support according to claim 1, wherein the supporting elements are arranged in a housing having an angled compartment at the base thereof.

4. The workpiece support according to claim 2, wherein the rollers include top rollers and bottom rollers, and the top rollers are connected to the bottom rollers via a drive.

5. The workpiece support according to claim 4, wherein the bottom rollers are connected to drive rollers.

6. The workpiece support according to claim 1, wherein the rows of supports are spaced from one another by distance (d1).

7. The workpiece support according to claim 6, wherein the supporting elements are spaced from one another by distance (d2).

8. The workpiece support according to claim 7 wherein distance (d2) is smaller than distance (d1).

9. The workpiece support according to claim 4 wherein the drive is a belt drive or a chain drive or a direct drive.

10. The workpiece support according to claim 1 for use in a cutting or shaping machining station of a machine tool for machining flat material in continuous or batch operation.

11. The workpiece support according to claim 1, wherein each of the supporting elements includes a roller carrier which terminates at a top end and a bottom end, a top roller is located at the top end on which the workpiece rests, and a bottom roller is connected to the top roller via a vertical belt drive.

12. The workpiece support according to claim 11, wherein the bottom roller extends along its axis into a drive roller, the drive roller is connected via a horizontal drive belt to a motor, and the motor drives the horizontal drive belt.

13. The workpiece support according to claim 12, wherein all of the drive rollers in a row of supports are actuated, the drive rollers move the bottom rollers, and the bottom rollers move the top rollers via the vertical drive belt when the motor is activated.

14. The workpiece support according to claim 1, wherein each supporting element is spaced from the adjacent supporting element by an interstice, each row of supports is spaced from the adjacent row of supports by an interstice, and the rows of supports are moveable linearly from left to right to allow a cutting process to be carried out along at least one of the interstices.

15. A method for placing a workpiece in a machining station, comprising the steps of:
supporting a workpiece on a horizontal plane by spaced supporting elements, wherein the supporting elements are arranged in at least two rows of supports; and
displacing at least one of the rows of supports along the horizontal plane.

16. The method according to claim 15, wherein each supporting element is spaced from the adjacent supporting element by an interstice, each row of supports is spaced from the adjacent row of supports by an interstice; and further comprising the step of:
cutting the workpiece along at least one of the interstices.

17. The method of claim 16, wherein the cutting step includes laser cutting the workpiece while the workpiece is supported by the supporting elements and after displacing at least one of the rows of supports.

18. The method according to claim 15, wherein each of the supporting elements includes a roller carrier which terminates at a top end and a bottom end, a top roller is located at the top end on which the workpiece rests, a bottom roller is connected to the top roller by a vertical belt drive, the bottom roller extends along its axis into a drive roller, the drive roller is connected via a horizontal drive belt to a motor; and further comprising the steps of:
activating the motor;
actuating all of the drive rollers in a row of supports via the activated motor;
moving the bottom rollers and the vertical drive belt via the actuated drive rollers; and
moving the top rollers via the moving vertical drive belt.

19. The method according to claim 15 including the step of displacing a plurality of the rows of supports along the horizontal plane independent of one another.

20. The method according to claim 15 including the step of displacing all of the rows of supports at once in the transverse direction.
